(19) United States
(12) Patent Application Publication
(10) Pub. No.: US 2003/0189038 A1
(43) Pub. Date: Oct. 9, 2003

(54) Method and device for baking compact coils

(75) Inventor: Djordjevic Milorad, Wien (AT)

Correspondence Address: Friedrich Kueffner, Suite 910, 317 Madison Avenue, New York, NY, 10017, US

(73) Assignee: AKG Acoustics GmbH

(21) Appl. No.: 10/382,717

(22) Filed: Mar. 6, 2003

(30) Foreign Application Priority Data
Mar. 13, 2002 (AT) A 388/2002

(51) Int. Cl. H05B 6/38; H05B 3/02

(52) U.S. Cl. 219/644; 219/469

(57) ABSTRACT

A method and device for winding and baking compact coils of wire with at least one baked enamel layer on a heated winding mandrel. The method includes providing the winding mandrel at the beginning of winding with a temperature which is above the softening temperature of the baked lacquer. The device includes at least one electrical heating cartridge arranged in the interior of the winding mandrel.

### BACKGROUND OF THE INVENTION

1. Field of the Invention

The present invention relates to a method and a device for baking compact coils.

2. Description of the Related Art

Compact coils within the scope of the instant description are coils whose wires, which are surrounded by a layer of at least one electrical insulator, are wound winding against winding and the windings are mechanically rigidly connected to each other by selecting suitable coatings of the wires and/or suitable methods. This is usually achieved by selecting surfaces of the wires which are mechanically rigidly connected to each other by the influence of heat alone, by adding solvents and the influence of heat, by adding ultraviolet-hardening adhesives and ultraviolet radiation, by adding various other adhesives during winding, or by a subsequent heat treatment.

Compact coils, which always have several layers, are required, for example, for electrodynamic microphones, electrodynamic headsets and electrodynamic loudspeakers. Usually so called baked lacquer wires are used for such coils. The uppermost or outermost lacquer layer of such wires becomes soft to viscous during heating and such layers can be rigidly connected to each other by the application of pressure and cooling. A method frequently used includes heating the wire during winding with hot air in order to achieve the connection of the contacting baked enamel layers during winding.

However, the hot air supplied during winding of the coil is harmful to the winding process itself, particularly when thin wires having a diameter of below 0.04 mm are used. The best possible strength and packing tightness of the coils can essentially also not be achieved because the supplied hot air negatively influences the winding process because optimum adjustment parameters with respect to coil strength cannot be achieved. Another problem exists in wires whose diameter is greater than 0.06 mm; at the usual winding speeds, these wires cannot absorb the heat required for baking. This means that winding must be carried out more slowly which makes the manufacture less economical. Of course, there is an intermediate range, i.e., wire diameters of 0.04 mm to 0.06 mm, in which both problems occur to a greater or lesser extent.

The problem of slow heating becomes more critical with increasing softening point of the used baked enamel wires. Of course, the temperature of the softening point is directly proportional to the temperature strength of the coil and, therefore, the temperature of the softening point should be generally high when considering, for example, the thermal load occurring in loudspeakers. In order to keep the winding times relatively short, hot air is supplied at high speed and in large quantities; this makes it necessary to wait a considerable time when starting the winding machine at the beginning of the layer until the entire winding area has reached a thermal equilibrium. Heating outputs of several kilowatt are typically used and require powerful cooling in the vicinity of the winding machine.

A method for manufacturing coils for electroacoustic transducers is disclosed in DE 27 43 439 A. In this method, the coil is wound onto a two-layer, flexible coil carrier which is placed on the winding mandrel provided with a heating cartridge, and subsequently the temperature of the coil is raised to baking temperature, for example, by contacting the coil wire, so that not only the windings bake together, but also the innermost layer bakes together with the outer side of the coil carrier. Concerning the operation and function of the heating cartridge, the reference merely mentions that “the winding mandrel is heated for winding.” However, the baking process itself explicitly takes place only after the end of winding. The two-layer coil carrier, which is beneficial for the mechanical strength, makes it impossible to achieve a high packing density.

In accordance with another known method of baking, the completely wound coil is removed together with the winding mandrel from the machine and the coil is heated together with the winding mandrel by means of the application of a current. When this type of heating is used, the center of the coil is usually overheated, while the border zones usually remain cold. An optimum coil strength and packing density can also not be achieved using this method.

In accordance with another possibility, the coils are wound onto separate sleeves which can be removed from the winding machine and the coils are then heated and baked in a furnace. Very good coils can be obtained by heating in a furnace, however, the coils do not have optimum strength and packing density. Another disadvantage of this method is the fact that the cycle times are long because the method is complicated.

### SUMMARY OF THE INVENTION

Therefore, it is the primary object of the present invention to provide a method of the above-described type in which baking of compact coils takes place quickly and uniformly in a simple manner, wherein the cycle times are kept short and the winding of coils can be optimized with respect to coil strength and packing density.

In accordance with the present invention, baked enamel wire coils are wound directly onto hot, internally heated mandrels. The heat required for baking is applied to the coil during winding and during the time in which the process requires the coil to be placed on the winding mandrel. Depending on the coil and the wires used with wire diameters of 0.02 mm to 0.3 mm, the required baking time is between 0.5 sec and 5.0 sec. The baking times are relatively short because the invention utilizes the very good heat contact between winding mandrel and coil.

The baking time and the winding mandrel temperature are selected in such a way that, by taking into consideration the thermal contact between winding mandrel and coil, the optimum coil strength and packing density are achieved. It is also essential that air is no longer blown against the area around the winding point, so that the winding process itself is significantly improved and more stable. In addition, the necessary heating output is significantly reduced, so that cooling also becomes unnecessary.

Consequently, the invention resides in that the winding surface of the winding mandrel has a temperature at the beginning of winding which is above the softening temperature of the baked lacquer. This causes the first layer to be secured immediately; also, the heat transfer and winding process take place simultaneously, so that, in accordance with a development of the invention, it is provided that the baked lacquer of each layer is softened approximately after one rotation of the winding mandrel.

A very simple method for heating the winding mandrel to the desired temperature is to use one or more electrical heating cartridges which are mounted in the mandrel as close as possible to the mandrel surface. The desired mandrel temperature can be easily measured and regulated by means of temperature sensors which are additionally mounted in the mandrel. Of course, all conventional methods for controlling the mandrel temperature can be used, including contactless infrared temperature measurement of the mandrel and coil surfaces.

### BRIEF DESCRIPTION OF THE DRAWING

In the drawing:

FIG. 1 is a side view of a mandrel;

FIG. 2 is an illustration, on a larger scale, showing mounting of several heating cartridges in a front view and in axial section; and

FIG. 3 is an illustration, similar to FIG. 2, showing an embodiment of a thin mandrel with only one heating cartridge.

### DETAILED DESCRIPTION OF THE INVENTION

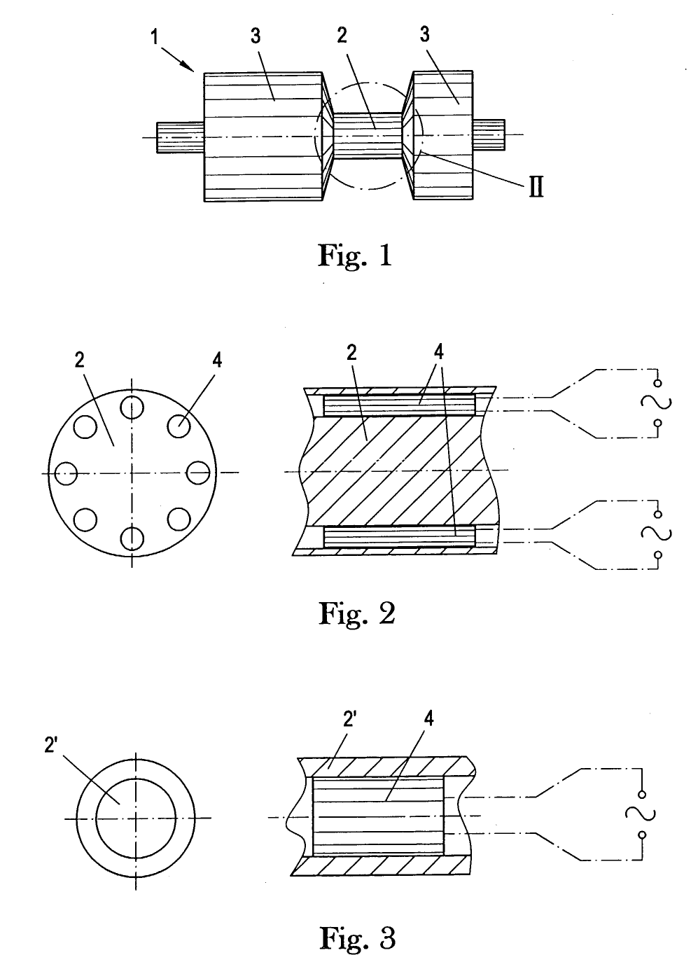

FIG. 1 of the drawing shows a winding mandrel 1 in a side view. The mandrel is composed of the actual mandrel 2 with winding surface and winding area; the mandrel 2 has shoulders 3 on both sides, wherein the distance between the shoulders 3 determines the axial length of the coils wound on the mandrel.

FIG. 2 shows in a schematic axial sectional view the mounting of several heating cartridges 4; specifically eight cartridges 4 are provided. These heating cartridges 4 are electrically heated and are commercially available. The arrangement of the cables and the control of the heating process is known in the prior art and, therefore, does not have to be explained in detail and is only schematically indicated in the drawing by dash-dot lines. The heating cartridges 4 are preferably uniformly distributed over the circumference and are located closely underneath the outer surface of the mandrel 2, i.e., the winding surface. Depending on the diameter of the mandrel 2, it is useful to mount three to eight heating cartridges.

FIG. 3 of the drawing shows the situation with a mandrel 2′ having a smaller diameter. In this case, it is sufficient to centrally mount a single heating cartridge 4 which may be of greater size.

Another possibility for heating the winding mandrel is to inductively heat the mandrel. For this purpose, a high frequency heating coil is positioned over the winding mandrel, wherein the heating coil heats the mandrel inductively to the desired temperature. This is a very elegant solution, however, with the disadvantage that the cycle times are increased by having to carry out the step of positioning the high frequency heating coil.

Another possibility is to heat the winding mandrel at a suitable location by means of a gas flame, for example, an oxyhydrogen gas flame. The winding mandrel may be hollow and the position of the nozzle for the flame within the winding mandrel may be selected in such a way that heating of the mandrel can also take place during winding. This method is useful if coils with large diameters and, thus, large copper quantities must be baked.

The above-described possibilities for heating the winding mandrel are intended to be examples of many other conceivable possibilities, such as heating of the mandrel by means of infrared radiation, hot air, etc., or by using the method of winding on hot sleeves which are externally heated and then placed on the mandrel.

Another advantage which can be achieved by the invention is the fact that winding is carried out quickly so that overheating of the wire is prevented. Cold wire is always wound onto a hot mandrel. At the end of the winding process, the innermost winding layer has already been slightly heated, while the mandrel has slightly cooled. Consequently, the finished coil can be easily pulled from the mandrel. The coil which has cooled to room temperature, in turn, has an internal diameter which corresponds to the diameter of the hot mandrel. The outer winding layers of the coil “shrink” during cooling and, thus, particularly tight and compact coils are obtained.

The coils are almost always wound fully automatically. Of course, in addition to the actual winding process, this requires various other steps, such as clamping and cutting the wire, closing and opening the machine, ejecting the coils, and the like. Normally, depending on the type of coil, the cycle times are 3 sec to 10 sec. These times are usually long enough for an optimum baking of the coils. If this should not be the case at any given time, an additional baking time must be provided in the cycle. Depending on the type of coil, the actual baking times are between 0.5 sec and 3 sec. It should also be mentioned that very little energy is required for baking the coils according to the present invention because only the winding mandrel itself must be heated. In contrast, when hot air is used, the entire surrounding area is heated in an undesired manner.

The invention is not limited to the embodiments described and illustrated herein. Rather, various modifications are possible. In particular, it is possible without problems to wind wires into coils whose cross-sections deviate from the circular shape. It is immaterial in this connection whether the outer circumference and/or the cross section of the metal core is polygonal, particularly rectangular, and usually with rounded corners.

While specific embodiments of the invention have been shown and described in detail to illustrate the inventive principles, it will be understood that the invention may be embodied otherwise without departing from such principles.

I claim:

1. A method for winding and baking compact coils of wire with at least one baked enamel layer on a heated winding mandrel, the method comprising providing the winding mandrel at the beginning of winding with a temperature which is above the softening temperature of the baked enamel.

2. The method according to claim 1, further comprising adjusting the temperature of the winding mandrel, of the supplied wire and the winding speed to each other such that the baked enamel reaches its softening temperature only after a period which is equal to a rotation of the winding mandrel.

3. A device for winding and baking compact coils of wire with at least one baked enamel layer, the device comprising a winding mandrel having an interior and at least one electrical heating cartridge arranged in the interior of the winding mandrel.

4. The device according to claim 3, further comprising an induction coil positionable essentially coaxially relative to the winding mandrel and moveable relative to the winding mandrel.

5. The device according to claim 3, wherein the interior of the winding mandrel is hollow, further comprising a gas burner having a gas flame, wherein the gas flame is directed into the hollow interior of the winding mandrel.

6. The device according to claim 3, further comprising a sleeve placed on the winding mandrel for winding the wire, wherein the sleeve is externally heatable and configured to be placed hot onto the winding mandrel.
